(19) United States
(12) Patent Application Publication
(10) Pub. No.: US 2001/0032926 A1
(43) Pub. Date: Oct. 25, 2001

(54) Optical scanning device capable of detecting commencement of scan

(76) Inventor: Mitsuhiro Ohno, Saitama (JP)

Correspondence Address: YOUNG & THOMPSON, 745 SOUTH 23RD STREET 2ND FLOOR, ARLINGTON, VA, 22202

(21) Appl. No.: 09/819,825

(22) Filed: Mar. 29, 2001

(30) Foreign Application Priority Data
Mar. 29, 2000 (JP) 2000-091554

(51) Int. Cl. H01J 3/14

(52) U.S. Cl. 250/235

(57) ABSTRACT

An optical scanning device of a type having a scanning optical system for deflecting scanning beams bearing image information of a common subject image which includes a polygon mirror and an ƒθ lens comprises a scanning beam separation mirror for separating the scanning beams in different directions and a pair of first and second reflection mirrors provided for each scanning beam, the first and second reflection mirrors being disposed on opposite sides, respectively so that the scanning beam travels across an axis of the scanning optical system. The optical scanning device is additionally provided with a scanning beam detector which provides a start signal for commencement of a scan timely when detecting the scanning beam directed toward a position immediately before a given scanning area.

### BACKGROUND OF THE INVENTION

1. Field of the Invention

The present invention relates to an optical scanning device of a type which scans an image carrier such as a photosensitive drum with a scanning beam of light, such as a scanning beam, so as to form an electrostatic latent image on the photosensitive drum and transfers the electrostatic latent image as a toner image onto a moving printing medium such as a printing paper, and, more particularly, to an optical scanning device which is capable of detecting commencement of a scan of a subject image carrier.

2. Description of the Related Art

There have been well known variety of tandem type image forming machines as a color copying machine and a color printer. Such a tandem type color image forming machine is equipped with a plurality of photosensitive drums disposed side by side. The photosensitive drums are exposed to scanning beams, respectively, for scan so as to form electrostatic latent image thereon. The electrostatic latent images on the photosensitive drums are developed as toner images and then transferred one after another to a printing medium such as a printing paper while the printing medium moves in a direction in which the photosensitive drums are arranged side by side, so as thereby to be printed as an entire color image on the printing medium.

The tandem type color image forming machine is typically equipped with four laser sources for producing four color image information, namely yellow (Y) image information, magenta (M image information, cyan (C) image information and black (3K) image information and four scanning optical systems, one for each photosensitive drum, through which scanning beams emanating from the laser sources are directed to the photosensitive drums to scam them, respectively, so as to form Y, M, C and BK electrostatic latent images on the photosensitive drums. One of the tandem type color image forming machines is known from, for example, Japanese Unexamined Patent Publication No. 11-295625.

Because this type of color image forming machine is equipped with a plurality of scanning optical systems one for each of a plurality of photosensitive drums, it is hard for the color image forming machine to be miniaturize and to be produced at low costs. As disclosed in, for example, Japanese Unexamined Patent Publications Nos. 6-286226,10-20608 and 10-133131, color image forming machines are equipped with a single scanning optical system commonly used to a plurality of photosensitive drums. The scanning optical system of such a color image forming machine includes optical deflection means and scanning beam separation means. The optical deflection means deflects scanning beams from laser sources of the same number as photosensitive drums employed in the color image forming machine commonly to the scanning beam separation means. The scanning beam separation means separates the four scanning beams so as to direct them separately to the photosensitive drums, respectively.

Before describing the present invention in detail, reference is made to FIGS. 3-5 for the purpose of providing a brief background in connection with a prior art optical scanning device that will enhance understanding of the optical scanning device of the present invention.

FIGS. 3 and 4 schematically show an optical scanning device of a conventional tandem type color image forming machine. As shown in FIG. 4, the optical scanning device includes a laser source 1 such as a semi-conductor laser array which generates four scanning beams of laser. The scanning beams emanating from the laser source 1 are collimated by a collimating lens 2 and a cylindrical lens 4. Each scanning beam is reflected by a first plane mirror 3 and a second plane mirror 4 so as to impinge on one of reflective facets 6a of an equilateral polygon deflection mirror 6 as scanning beam deflection means which rotates at a fixed speed of rotation. The scanning beam after reflection by the reflective facet 6a of the polygon deflection mirror 6 travels to an inequilateral polygon separation mirror 8 as scanning beam separation means passing through an ƒθ lens system 7. The four parallel scanning beam impinge on and are separated by the polygon separation mirror 8 so as to travel in four different directions in which first to fourth cylindrical mirrors 11-14 are disposed, respectively, as shown in FIG. 3. The scanning beams are reflected by the first to fourth cylindrical mirrors 11-14, respectively, and impinge on four photosensitive drums at image forming positions 10, respectively, so as thereby to form Y, M, C and BL electrostatic latent images on the photosensitive drums rotating at a fixed same speed of rotation, respectively. Specifically, because each photosensitive drum continuously rotates about an axis of rotation perpendicular to an axis of rotation Y of the polygon deflection mirror 6, the scanning beam continuously moves back and forth along a straight line on tie photosensitive drum in a direction in parallel with the axis of rotation of the photosensitive drum in synchronism with rotation of the polygon deflection mirror 6, so as to scan lines on the photosensitive drum in the direction parallel with the axis of rotation of the photosensitive drum. The direction in parallel with the axis of rotation of the photosensitive drum is hereafter named a primary scanning direction. On the other hand, although the scanning beam itself is fixed in position in a direction in parallel with the axis of rotation Y of the polygon deflection mirror 6, in other word, in a direction perpendicular to the axis of rotation of the photosensitive drum, the scanning beam continuously shifts in position relative to the photosensitive drum in synchronism with rotation of the photosensitive drum in the direction perpendicular to the axis of rotation of the photosensitive drum. The direction perpendicular to the axis of rotation of the photosensitive drum is hereafter named a secondary scanning direction.

As shown in FIG. 5, the polygon separation mirror 8 has four reflective facets 8a-8d at different angles with respect to an optical axis of the optical scanning system, in particular, the ƒθ lens system 7. The scanning beams impinge at different incident angles on the reflective facets 8a-8d, respectively, and then are reflected in different directions according to the incident angles. The polygon separation mirror 8 is formed as a one piece comprising two sections, namely a lower mirror section 9a having a generally trapezoidal section and an upper mirror section 9b having a generally isosceles triangular section. In this instance, the upper mirror section 9b has equilateral side surfaces forming the reflective facets 8b and 8c each of which has an optical axis intersecting the optical axis X of the ƒθ lens system 7 at an angle smaller than angle at which the optical axis of each of equilateral side surfaces of the lower mirror section 9a forming the reflective facets 8a and 8d intersects the optical axis X of the ƒθ lens system 7. The scanning beams reflected by the reflective facets 8a and 8d and the scanning beams reflected by the reflective facets 8b and 8c are symmetrical in position with respect to the optical axis X of the ƒθ lens system 7, respectively.

The first to fourth cylindrical mirrors 11 to 14 are located in the optical axes of the equilateral side reflective facets 8a- 8d, respectively. Specifically, the first and fourth cylindrical mirrors 11 and 14 are symmetrical in position with respective to the optical axis X of the ƒθ lens system 7. Similarly, the second and third cylindrical mirrors 12 and 13 are symmetrical in position with respective to the optical axis X of the ƒθ lens system 7. Further, the first to fourth cylindrical mirrors 11 to 14 are so located as to provide optical paths for the scanning beams between the laser source 1 and the image forming position 10 on the photosensitive drums with optical path lengths, respectively, which are equal to one another.

The optical scaring device is additionally provided with a scanning beam detector comprising a plane mirror 15 and a photo sensor 16. The plane mirror 15 is located near an extreme end from which a scan commences in the primary scanning direction so as to reflect the scanning beam from the polygon deflection mirror 6. The photo sensor 16 is located so as to receive the scanning beam reflected by the plane mirror 15. The photo sensor 16 provides a control signal for commencing a scan at a timing of receiving the scanning beam from the plane mirror 15.

It is typical to miniaturize the color image forming machine by installing an optical scanning device which employs a common optical scanning system including scanning beam separation means for a plurality of scanning beams. However, the inventors of this application have developed a significantly miniaturize optical scanning device by shortening a distance between the polygon deflection mirror 6 as scanning beam deflection means and the polygon separation mirror 8 as scanning beam separation means. The shortened distance between the two mirrors 6 and 8 can cause the scanning beams reflected by the polygon deflection mirror 6 and passing through the ƒθ lens system 7 to diverge gradually but not in excess before separation from one another by the polygon separation mirror 8. This is desirable for reliable separation of the scanning beams.

However, when disposing the scanning beam detector comprising the plane mirror 15 and photo sensor 16 in a space provided between the polygon deflection mirror 6 and polygon separation mirror 8 disposed at a shortened distance, since there is a structural demand of providing a sufficient space for disposing the scanning beam detector in position in the optical scanning device, notwithstanding the effort of shortening the distance between the polygon deflection mirror 6 and polygon separation mirror 8, there is possible hindrance to miniaturization of the optical scanning device. Specifically, the shorter the distance between the polygon deflection mirror 6 and polygon separation mirror 8 becomes, the larger the largest scanning angle θ is. Since the plane mirror 15 of the scanning beam detector has to be out of a permissible or given scanning area defined by the largest scanning angle θ, the optical scanning device must be bulky due to at least a space for the plane mirror 15 of the scanning beam detector. Further, since the photo sensor 16 of the scanning beam detector is desirably located in a position at a distance from the polygon deflection mirror 6 equivalent to an image distance, i.e. the distance to the photosensitive drum from the polygon deflection mirror 6, the distance between the plane mirror 15 and photo sensor 16 of the scanning beam detector becomes long with a decrease in the distance between the polygon deflection mirror 6 and the plane mirror 15 of the scanning beam detector. In consequence, the photo sensor 16 of the scanning beam detector must be located far away aside from the optical axis of the scanning optical system, so that the optical scanning device must be also bulky due to a space for the photo sensor 16 of the scanning beam detector. In addition, since the distance between the polygon deflection mirror 6 and polygon separation mirror 8 becomes shorter, it becomes hard to provide a sufficient space for the plane mirror 15 and photo sensor 16 of the scanning beam detector in positional relation with other optical elements and mechanical parts of the optical scanning device.

The plane mirror 15 of the scanning beam detector is preferably located at as long distance from the polygon deflection mirror 6 as possible in order for the scanning optical system to have an adverse effect on the largest scanning angle θ as small as possible. As shown in FIG. 6 explanatorily showing an extent of reflection of a scanning beam by plane mirrors 15a and 15b located at different distances from the polygon deflection mirror 6, when the plane mirrors 15a and 15b have the same size of reflective surface areas, the scanning beam reflected by the plane mirror 15a can impinge on a specified area of the photo sensor 16 as long as it deflects on the plane mirror 15a through a deflection angle δ1. Under the same condition, the scanning beam reflected by the plane mirror 15b, located closer to the polygon deflection mirror 6 than the plane mirror 15a, can impinge on the specified area of the photo sensor 16 as long as it deflects on the plane mirror 15b through a deflection angle δ2. As apparent, the deflection angle δ2 with respect to the plane mirror 15b is greater than the deflection angle δ1 with respect to the plane mirror 15a. In consequence, in order for the plane mirror 15b to avoid partly overlap of the comparatively large deflection angle δ2 and the largest scanning angle θ, there is a restraint on the largest scanning angle θ. On the other hand, the plane mirror 15a, located farther away from the polygon deflection mirror 6 than the plane mirror 15b, allows the polygon deflection mirror 6 to reflect and deflect the scanning beam through the largest scanning angle θ greater than the plane mirror 15b. That is, the longer the distance from the polygon deflection mirror 6 at which the plane mirror 15 is located is, the greater the largest scanning angle θ is, so that a longer distance of the plane mirror 15 is advantageous to miniaturization of the color image forming machine.

### SUMMARY OF THE INVENTION

It is therefore an object of the present invention to provide an optical scanning device capable of detecting commencement of a scan for an image forming machine.

It is another object of the present invention to provide an optical scanning device capable of detecting commencement of a scan which is contributory to miniaturization of the image forming machine in addition to its own compactness.

It is another object of the present invention to provide an optical scanning device capable of detecting commencement of a scan which is suitable for shorting a distance between deflection means and scanning beam separation means

The foregoing objects of the present invention are accomplished by an optical scanning device capable of detecting commencement of a scan which comprises reflective deflection means for reflecting and deflecting a scanning beam of light, such as a laser beam, bearing image information of a subject image, reflection means for reflecting and directing the scanning beam of light reflected and deflected by the reflective deflection means so that the scanning beam impinges on image carrying means to scan at least a given scanning area of the image carrying means in a direction in which the reflective deflection means deflects the scanning beam impinging thereon, and scanning beam detection means for detecting commencement of a scan of the given scanning area in that direction. The scanning beam detection means comprises a reflection mirror which reflects back the scanning beam directed by the reflection means directed toward said image carrying means in a position before the given scanning area and a photo sensor disposed in a position where receiving the scanning beam reflected by the reflection mirror. The reflective deflection means are known in various forms in the art and may take a well known form such as one comprising a rotary polygon mirror and an ƒθ lens system.

The reflection means covers over the deflection angle of scanning beam of light meeting the given scanning area on the image carrying means and receives a scanning beam of light that is deflected and directed toward the outside of the given scanning area of the image carrying means by the reflective deflection means. The reflection mirror of the scanning beam detector reflects the scanning beam of light directed toward the outside of the given scanning area of the image carrying means back to the reflection means. The reflection means reflects the scanning beam from the reflection mirror of the scanning beam detector toward the reflective deflection means at an angle according to an incident angle of the scanning beam thereupon. Accordingly, the photo sensor of the scanning beam detector is put in an appropriate position excluded from the deflection angle of scanning beam meeting the given scanning area but as close to the reflective deflection means as possible so as to prevent the scanning beam reflected back by the reflection means from crossing or overlapping the path of scanning beam reaching the extreme end of the given scanning area That is, the photo sensor of the scanning beam detector is located in a desired position where it keeps the scanning beam from impinging to the reflective deflection means including the ƒθ lens system. The scanning beam, after detection by the scanning beam detector, is continuously deflected to move between the extreme ends of the given scanning area of the image carrying means, so as thereby to form an image, for example an electrostatic latent image, on the image carrying means such as a photosensitive drum. The scanning beam detector provides a timing signal for appropriate commencement of a scan when receiving the scanning beam.

According to the optical scanning device thus constructed, since the reflection mirror of the scanning beam detector is located so as to receive a scanning beam reflected by the reflection means covering deflection of the scanning beam covering over a given scanning area, the optical scanning device has the necessity of having a space for the scanning beam detector smaller as compared with an optical scanning device which is provided with a scanning beam detector adapted to detect a scanning beam immediately after reflective deflection means including an ƒθ lens system.

In the case where the optical scanning device employs a plurality of scanning beams of light bearing image information of the same subject image, the reflection means is of a type which reflects and directs the scanning beams reflected and deflected by the reflective deflection means in different directions, respectively, so that the scanning beams impinge on a plurality of image carrying means, respectively, to scan given scanning areas of the image carrying means, respectively, in a direction in which the reflective deflection means, deflects the scanning beams, the scanning beam detection means comprises a reflection mirror for reflecting back one of the scanning beams directed toward a position on said image carrying means before said given scanning area by the reflection means and a photo sensor operative to receive the scanning beam reflected by the reflection mirror.

When the optical scanning device is used together with a color image forming machine of a tandem type which is provided with a plurality of image carrying means, a corresponding number of scanning beams are used, one for a scan of each image carrying means. In the case where the optical scanning device is provided with a single reflective deflection means commonly to the scanning beams for reflecting and deflecting the scanning beams, simultaneously or separately, the reflection means is used as beam separation means for separating the scanning beams reflected and deflected by the reflective deflection means into different directions and directing them to the image carrying means, respectively. The reflection mirror of the scanning beam detector receives the scanning beam after separation and reflects it back to the reflection means, i.e. the scanning beam separation means. The photo-sensor of the scanning beam detector can be located in a desired position where it keeps the scanning beam from impinging on the reflective deflection means including the ƒθ lens system.

In the case where the reflective deflection means reflects and deflects the scanning beams bearing image information of the same subject image simultaneously, it is suffice fort he reflection mirror to receive one of the scanning beams. On the other hand, in the case where the reflective deflection means reflects and deflects the scanning beams separately at different timings, the scanning beam detector is provided one for each scanning beam so as to make starting points of scans of the respective image carrying means identical. The scanning beam detectors provide timing signals, one for each image carrying means, for commencement of cans of the image carrying means at appropriate but different timings.

The photo sensor of the scanning beam detector is preferably disposed near the reflective deflection means. This arrangement of the photo sensor avoids the necessity of providing the scanning optical system with an increased space for the scanning beam detector. This is advantageous to miniaturization of the optical scanning device. Moreover, the optical scanning device allows the optical path length to the photo sensor from the reflection means or the scanning beam separation means to be adjusted by changing the optical path length to the reflection mirror of the scanning beam detector from them. This enables disposing the photo sensor of the scanning beam detector close to the reflective deflection means.

### BRIEF DESCRIPTION OF THE DRAWINGS

The above and other objects and features of the present invention will be clearly understood from the following description with respect to the preferred embodiments thereof when considered in conjunction with the accompanying drawings, in which:

FIG. 1 is a schematic diagrammatic side view of an optical scanning device capable of detecting commencement of a scan in accordance with a preferred embodiment of the present invention that is installed to an image forming machine by way of example;

FIG. 2 is a front view of the optical scanning device shown in FIG. 1;

FIG. 3 is a schematic diagrammatic side view of a prior art optical scanning device capable of detecting commencement of a scan that is installed to an image forming machine;

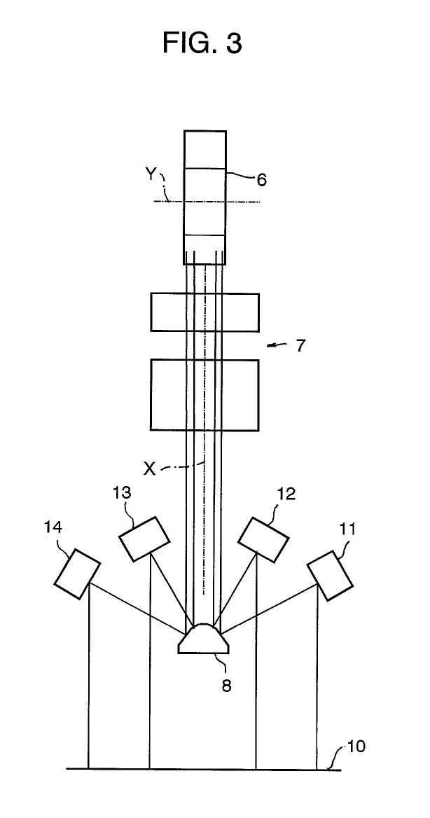

FIG. 4 is a front view of the prior art optical scanning device shown in FIG. 3;

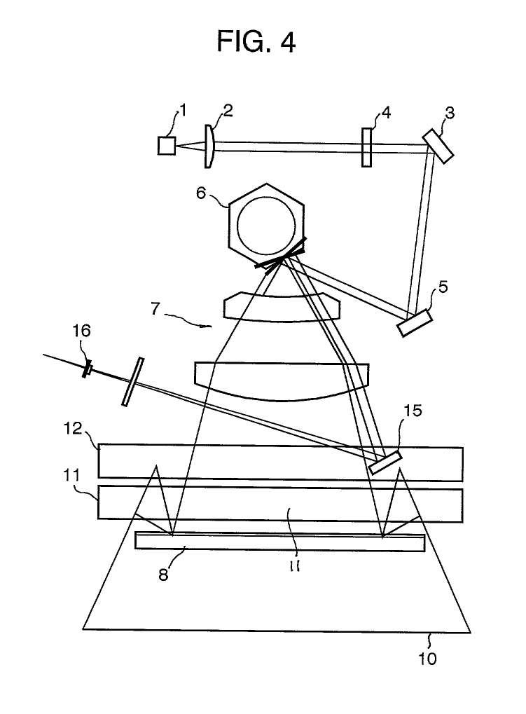

FIG. 5 is an explanatory view showing a scanning beam separation element of the prior art optical scanning device; and

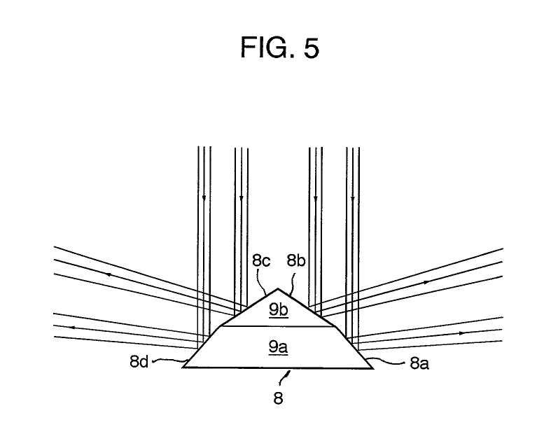

FIG. 6 is an explanatory view showing a difference between deflection angles of a scanning beam according to locations of a mirror of a scanning beam detector of an optical scanning device.

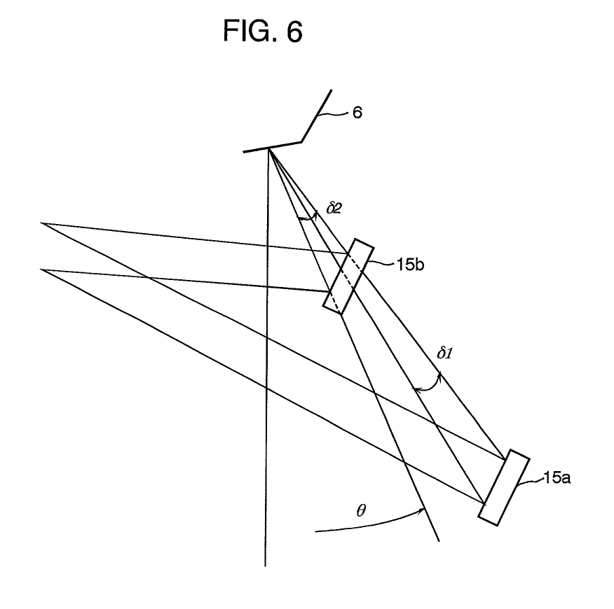

### DETAILED DESCRIPTION OF THE PREFERRED EMBODIMENT

Parts which are not direct importance to the invention and parts which are purely of conventional construction will not be described in detail since their construction and operation can easily be arrived at by those skilled in the art.

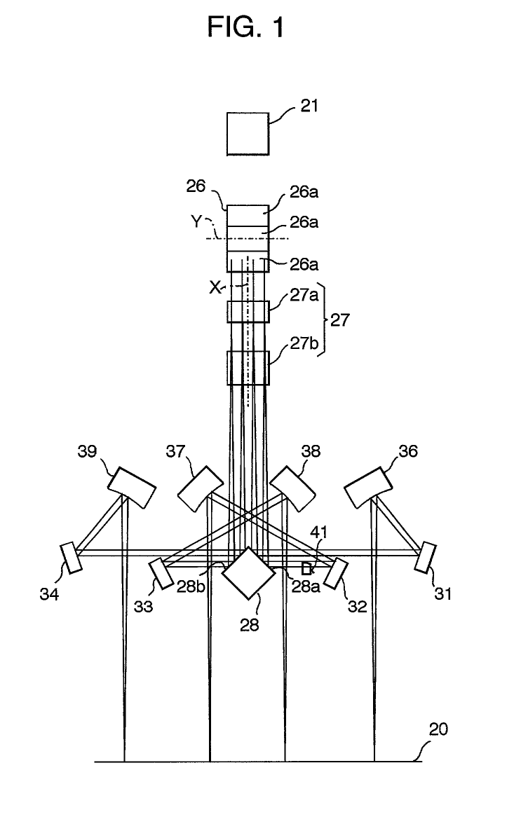

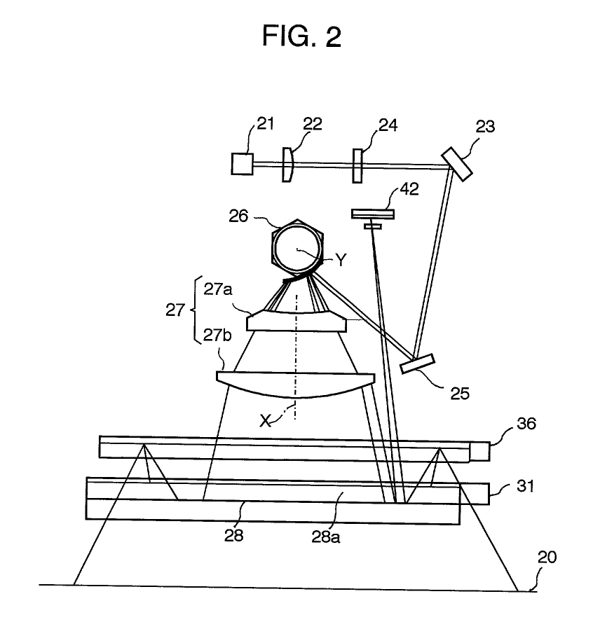

Referring to the drawings in detail, and, in particular, to FIGS. 1 and 2 showing an optical scanning device capable of detecting commencement of a scan in accordance with a preferred embodiment of the present invention, the optical scanning device includes a laser source 21, such as, for example, a semi-conductor laser array, which generates four scanning beams of light such as laser. The scanning beams bear image information, namely yellow (Y) image information, magenta (M) image information, yellow (Y) image information and black (BL) image information, respectively. The scanning beams emanating from the laser source 21 are collimated by a collimating lens 22 and a cylindrical lens 24. Each scanning beam is reflected by a first plane mirror 23 and a second plane mirror 24 in order so as to impinge on one of reflective facets 26a of a polygon deflection mirror 26 such as a hexagon mirror equilateral in cross-section which rotates at a fixed speed of rotation. The polygon deflection mirror 26 reflects and deflects the scanning beam by the reflective facets 26a successively. As a result, the scanning beam travels to a stationary polygon separation mirror 28, such as a mirror quadrilateral in cross-section, as scanning beam separation means passing through an ƒθ lens system 27 comprising lenses 27a and 27b. The polygon deflection mirror 26, which is of; for example, an equilateral hexagon, has six reflective facets at the respective sides.

The polygon separation mirror 28, which is quadrilateral in cross-section, has two reflective facets 28a and 28b, each reflective facet being formed in a plane including one of adjacent sides of the quadrangle and parallel with to axis of rotation of the polygon deflection mirror 26. The polygon separation mirror 28 at adjacent sides other than the reflective facets 28a and 28b may be finished preferably for stable installation to the optical scanning device. The polygon separation mirror 28 is positioned so as to receive the four scanning beams, two at each side of an edge line along which the adjacent reflective facets 28a and 28b intersects. Each of the reflective facets 28a and 28b is at an angle of 45° with respect to a reference plane which is a plane including the edge line and parallel with the scanning beams incident upon the polygon separation mirror 28.

On opposite sides of the polygon separation mirror 28 there are first to fourth plane mirrors 31-34, two on each side. The plane mirrors 31-34 reflect and fold the scanning beams incident thereupon backward, respectively, so as to direct them to cylindrical mirrors 36-39, respectively. Specifically, the first and the fourth plane mirrors 31 and 34 are at the same distances in an axial direction of the ƒθ lens system 27 and symmetrical in position with respect to the polygon separation mirror 28. Similarly, the second plane mirror 32 and the third plane mirror 33 are at the same distances in an axial direction of the ƒθ lens system 27 and symmetrical in position with respective to the polygon separation mirror 28. The first plane mirror 31 and the fourth plane mirror 34 are farther away aside from the polygon separation mirror 28 in the primary scanning direction than the second plane mirror 32 and the third plane mirror 33, respectively. Further, the first plane mirror 31 and the fourth plane mirror 34 are closer to the polygon deflection mirror 8 than the second plane mirror 32 and the third plane mirror 33. According to the arrangement of the first to fourth plane mirrors 31-34 relative to the polygon separation mirror 28, the parallel scanning beams impinging on the polygon separation mirror 28 are separated and directed to the plane mirrors 31-34 different in position.

The plane mirrors 31-34 reflect the separate scanning beams and direct them in four different directions, respectively, in which first to fourth cylindrical mirrors 36-39 are located in a substantially straight line in the primary scanning direction and closer to the polygon deflection mirror 8 in the axial direction of the axial direction of the ƒθ lens system 27, respectively, as shown in FIG. 1. In order for optical paths for the four scanning beams to have optical path lengths between the laser source 1 and the image forming positions 10 on the photosensitive drums, respectively, which are equal to one another, the first to fourth cylindrical mirrors 36-39 are arranged in specific relative positions. Specifically, the first cylindrical mirror 36 and the third cylindrical mirror 38 are located on one side of the polygon separation mirror 28 in the primary scanning direction. The second cylindrical mirror 37 and the fourth cylindrical mirror 38 are located on another side of the polygon separation mirror 28 in the primary scanning direction. Further, the first cylindrical mirror 36 and the fourth cylindrical mirror 38 are farther away aside from the polygon separation mirror 28 in the primary scanning direction than the second cylindrical mirror 37 and the third cylindrical mirror 38, respectively. The cylindrical mirrors 36-39 reflect the scanning beams incident thereupon and direct them to an image carrier (not shown) comprising, for example, four photosensitive drams.

The respective scanning beams impinge on the four photosensitive drums at image forming positions 20, respectively, and scan the photosensitive drums in the primary and secondary directions, so as thereby to form Y, M, C and BL electrostatic latent images on the photosensitive drums, respectively. The photosensitive drums as image carrier rotate at the same fixed speed of rotation. While the photosensitive drum continuously rotates about an axis of rotation perpendicular to an axis of rotation Y of the polygon deflection mirror 26, the scanning beam continuously moves back and forth along a straight line on the photosensitive drum in synchronism with rotation of the polygon deflection mirror 26, so as to scan lines on the photosensitive drum from one extreme end to an opposite extreme end of a permissible or given scanning area in the primary scanning direction in synchronism with rotation of the polygon deflection mirror 26. Simultaneously, the scanning beam continuously shifts in position relative to the photosensitive drum in the secondary scanning direction in synchronism with rotation of the photosensitive drum.

The optical scanning device is additionally provided with a scanning beam detector comprising a plane mirror 41 (see FIG. 1) which is disposed near the polygon separation mirror 28 and a photo sensor 42 (see FIG. 2) which is disposed near the polygon deflection mirror 26. The plane mirror 41 is located in an optical path of one of the scanning beams which is separated from the other three and directed to, for example, the plane mirror 32. Specifically, the plane mirror 41 receives the scanning beam immediately before it services to a scan. In this sense, the scanning beam impinges on the plane mirror 41 is called an unconcerned scanning beam in this specification. The plane mirror 41 reflects the unconcerned scanning beam at a certain reflection angle back to the reflective facet 28a of the polygon separation mirror 28. The polygon separation mirror 28 then reflects the unconcerned scanning beam once again and directs it to the photo sensor 42. The photo sensor 42 can be adjusted in position in the direction in which the polygon deflection mirror 26 deflects the unconcerned scanning beam impinging thereon by regulating the reflection angle of the unconcerned scanning beam by the plane mirror 41. The photo sensor 42 provides a control signal for commencing a scan at a timing of receiving the unconcerned scanning beam from the polygon separation mirror 28. The photo sensor 42 is so positioned as to provide an optical path from the polygon deflection mirror 26 to the photo sensor 42 and an optical path from the polygon deflection mirror 26 to the image forming position 20 with optical path lengths, respectively, which are equal to each other. In other words, the photo sensor 42 is in an optically equivalent position to the image forming position 20.

In operation of the optical scanning device thus structured, the four scanning beams emanating from the laser source 21 are collimated by the collimating lens 22 and the cylindrical lens 24. Each scanning beam is reflected by the first plane mirror 23 and the second plane mirror 25 in order so as to be directed to the polygon deflection mirror 26 which is continuously rotating. The polygon deflection mirror 26 reflects the scanning beam impinging on a reflective facet 26a at a reflection angle which continuously varies with time. As a result, the scanning beam is deflected from one of the opposite extreme ends to another extreme end of the given scanning angle θ in the primary scanning direction. In other words, the scanning beam continuously shifts its incident position on the ƒθ lens system 27 according to a rotational angle of the polygon deflection mirror 8. The scanning beam passes through the ƒθ lens system 27 and then impinges on one of the facet 28a of the stationary polygon separation mirror 28 at a position which continuously shifts from one of opposite ends to another end. At this time, the four scanning beams are substantially parallel with one another and divided into two groups. One group of two scanning beams impinge on one of the reflective facets 28a and 28b intersecting at a right angle. Another group of two scanning beams impinge on another of the reflective facets. The two groups of scanning beams are almost symmetrical in incident position with respect to the reference plane.

At the early stage of deflection of the scanning beam by the polygon deflection mirror 8, an unconcerned scanning beam impinges on and is reflected by the facet 28a of the polygon separation mirror 28 at a position corresponding to a position of the photosensitive drum immediately before an extreme end of the given scanning area (a starting position of scan) in the primary scanning direction. The unconcerned scanning beam impinges on and is reflected back to the polygon separation mirror 28 by the plane mirror 41 of the scanning beam detector. The unconcerned scanning beam impinges on and is reflected again by the polygon separation mirror 28, and then travels to the photo sensor 42 of the scanning beam detector. When the unconcerned scanning beam impinges on the photo sensor 42, that is, when the unconcerned scanning beam deflected by the polygon deflection mirror 8 reaches the starting position of scan on the photosensitive drum in the primary scanning direction, the photo sensor 42 provides a signal which is timed to start rotation of the photosensitive drums at predetermined relative timings, respectively, so as thereby to commence a scan covering the given scanning area.

Two parallel scanning beams impinge on each facet 28a, 28b of the polygon separation mirror 28 at different incident positions, respectively. Because of an intersecting angle of 45° of the reflective surface of the facet 28, 28b of the polygon separation mirror 28 with respect to the reference plane, the respective two scanning beams are reflected to turn at an angle of 90° with respect to the reference plane, so as to travel to the plane mirrors 31 and 32, or 33 and 34, still in parallel with each other. The scanning beam reflected by the first plane mirror 31 travels to the first cylindrical mirror 36 disposed comparatively farther away from the optical axis X of the ƒθ lens system 27 but comparatively closer to the first plane mirror 31. The scanning beam reflected by the second plane mirror 32 travels, crossing the optical axis X of the ƒθ lens system 27, to the second cylindrical mirror 37 disposed comparatively closer to the optical axis X of the ƒθ lens system 27. Similarly, the scanning beam reflected by the third plane mirror 33 travels, crossing the optical axis X of the ƒθ lens system 27, to the third cylindrical mirror 38 disposed comparatively closer to the optical axis X of the ƒθ lens system 27. The scanning beam reflected by the fourth plane mirror 34 travels to the fourth cylindrical mirror 39 disposed comparatively farther away from the optical axis X of the ƒθ lens system 27 but comparatively closer to the fourth plane mirror 34. As a result, the scanning beams are separately focused on the photosensitive drums in the image forming positions 20 at appropriate intervals.

Because the second cylindrical mirror 37 and the third cylindrical mirror 38 are disposed in position opposite to the second plane mirror 32 and the third plane mirror 33 with respect to the polygon separation mirror 28 or the optical axis X of the ƒθ lens system 27, although the second plane mirror 32 and the third plane mirror 33 are at comparatively short distances from the polygon separation mirror 28, the optical path lengths to the second cylindrical mirror 37 and the third cylindrical mirror 38 from the polygon separation mirror 28, respectively, can be as sufficiently long as required. In consequence, the path lengths for the scanning beams between the polygon deflection mirror 8 and the image forming positions 20 can be substantially equal to one another. This makes it certain to focus the scanning beams as spots identical in diameter with one another on the photosensitive drums. Accordingly, electrostatic latent images on the photosensitive drums are geometrically identical with one another.

Although the present invention has been described in connection wit by way of example, the optical scanning device equipped with scanning beam separation means for separating a plurality scanning beams from one another in different directions, it may be embodied in an optical scanning device which uses a single scanning beam. The scanning beam separation means is employed when more than two scanning beams are used. In the case where an even number of scanning beams are used, it is preferred to separate the scanning beams into two groups of even numbers of scanning beams in opposite directions with respect to the scanning beam separation means.

As apparent from the above description, according to the optical scanning device capable of detecting commencement of a scan, the scanning beam detector is configured so as to detect a scanning beam reflected by a mirror and directed to a photo sensor after passing through an ƒθ lens system. This configuration avoids the necessity of providing the scanning optical system with an increased space for the scanning beam detector. This is more advantageous to miniaturization of the optical scanning device as compared with optical scanning devices equipped with a scanning beam detector for detecting a scanning beam immediately after passing through an ƒθ lens system. Moreover, the optical scanning device of the present invention eliminates various optical parts from having positional restraints on the arrangement of optical parts of the scanning beam detector. This enables location of the scanning beam deflection means at a short distance from the scanning beam separation means, which is advantageous to miniaturization of the optical scanning device, and hence to miniaturization of the color image forming device. In addition, according to the optical scanning device capable of detecting commencement of a scan, the scanning optical system is prevented from having an installation space expanded due to arrangement of the scanning beam scanning beam detection means. This is also advantageous to miniaturization of the optical scanning device.

It is to be understood that although the present invention has been described with regard to a preferred embodiment thereof, various other embodiments and variants may occur to those skilled in the art, which are within the scope and spirit of the invention, and such other embodiments and variants are intended to be covered by the following claims.

What is claimed is:

1. An optical scanning device comprising reflective deflection means for reflecting and deflecting a scanning beam of light bearing image information of a same subject image, reflection means for reflecting and directing said scanning of light reflected and deflected by said reflective deflection means so that said scanning beam of light impinges on image carrying means to scan at least a given scanning area of said image carrying means in a direction in which said reflective deflection means deflects said scanning of light, and scanning beam detection means for detecting commencement of a scan of said given scanning area, said scanning beam detection means comprising:
a reflection mirror for reflecting back said scanning of light directed by said reflection means toward a position on said image carrying means adjacent to said given scanning area; and
a photo sensor disposed in a position where receiving said scanning of light reflected by said reflection mirror, said photo sensor providing a signal indicating that said scanning beam reaches an extreme end of said given scanning area.

2. An optical scanning device as defined in claim 1, wherein said photo sensor is disposed near said reflective deflection means.

3. An optical scanning device comprising reflective deflection means for reflecting and deflecting a plurality of scanning beams of light bearing image information of a same subject image, reflection means for reflecting and directing said scanning beams of light reflected and deflected by said reflective deflection means in different directions, respectively, so that said scanning beams of light impinge on a plurality of image carrying means, respectively, to scan given scanning areas of said image carrying means, respectively, in a direction in which said reflective deflection means deflects said scanning beams of light, and scanning beam detection means for detecting commencement of a scan of said given scanning areas, said scanning beam detection means comprising:
a reflection mirror for reflecting back at least one of said scanning beams of light directed by said reflection means toward a position on said image carrying means before said given scanning area; and
a photo sensor operative to receive said scanning beam of light reflected by said reflection mirror.

4. An optical scanning device as defined in claim 1, wherein said photo sensor is disposed near said reflective deflection means.
